(19) United States
(12) Patent Application Publication
(10) Pub. No.: US 2023/0312919 A1
(43) Pub. Date: Oct. 5, 2023

(54) POLYMER BLENDS OF ALIPHATIC POLYKETONE AND ACRYLONITRILE BUTADIENE STYRENE

(71) Applicant: Avient Corporation, Avon Lake, OH (US)

(72) Inventors: Zachary Zander, Lake Geneva, WI (US); John Swanson, Lakewood, OH (US)

(73) Assignee: Avient Corporation, Avon Lake, OH (US)

(21) Appl. No.: 18/023,717

(22) PCT Filed: Aug. 26, 2021
(86) PCT No.: PCT/US2021/047752

§ 371 Date: Feb. 27, 2023

Related U.S. Application Data
(60) Provisional application No. 63/071,919, filed on Aug. 28, 2020.

(51) Int. Cl. C08L 73/00; C08L 55/02; C08K 3/32

(52) U.S. Cl. CPC C08L 73/00; C08L 55/02; C08K 3/32; C08K 2003/325

(57) ABSTRACT

Embodiments of the present disclosure are directed to polymer blends comprising greater than or equal to 55 wt % and less than or equal to 90 wt % of an aliphatic polyketone; and greater than or equal to 10 wt % and less than or equal to 40 wt % of an acrylonitrile butadiene styrene (ABS), wherein the aliphatic polyketone has a melt flow rate greater than or equal to 1 g/10 min and less than or equal to 90 g/10 min as measured in accordance with ASTM D1238 at 240° C. and a weight of 2.16 kg.

### CLAIM OF PRIORITY

This application claims the benefit of U.S. Provisional Patent Application Ser. No. 63/071,919 bearing Attorney Docket Number 12020009 and filed on Aug. 28, 2020, which is hereby incorporated by reference in its entirety.

### TECHNICAL FIELD

Embodiments of the present disclosure are generally related to polymer blends, and are specifically related to polymer blends of aliphatic polyketone and acrylonitrile butadiene styrene (ABS) having improved chemical resistance.

### BACKGROUND

Polymer blends of acrylonitrile butadiene styrene (ABS) and polycarbonate (PC) are widely used, such as in healthcare, automotive, and electronic applications, due to their relatively high heat resistance and combination of tensile strength and toughness. ABS improves the processability and flexibility of the polymer blend, but its upper glass transition temperature of approximately 95 to 105° C. limits the ability to use the blend in high temperature applications. To balance out the ABS, PC is added to increase the heat resistance of the polymer blend.

While ABS imparts its resistance to aqueous solutions to the ABS and PC blend, ABS and PC blends have relatively poor chemical resistance, particularly towards organic solvents, hydrocarbons, and select alcohols, and may not be sufficient for certain applications in the healthcare, automotive, and electronic fields.

Accordingly, a continual need exists for improved polymer blends that provide the desired chemical resistance while providing improved heat resistance and sufficient tensile and flexural strength and stiffness for the aforementioned applications.

### SUMMARY

Embodiments of the present disclosure are directed to polymer blends of aliphatic polyketone and ABS, which meet the desired chemical resistance while providing improved heat resistance and sufficient tensile and flexural strength and stiffness. Additionally, these polymer blends may exhibit improved impact strength.

According to one embodiment, a polymer blend is provided. The polymer blend comprises greater than or equal to 55 wt % and less than or equal to 90 wt % of an aliphatic polyketone; and greater than or equal to 10 wt % and less than or equal to 40 wt % of an acrylonitrile butadiene styrene (ABS), wherein the aliphatic polyketone has a melt flow rate greater than or equal to 1 g/10 min and less than or equal to 90 g/10 min as measured in accordance with ASTM D1238 at 240° C. and a weight of 2.16 kg.

Additional features and advantages of the embodiments described herein will be set forth in the detailed description which follows, and in part will be readily apparent to those skilled in the art from that description or recognized by practicing the embodiments described herein, including the detailed description, which follows and the claims.

### DRAWINGS

FIG. 1 is a photograph of sample bars formed using a comparative example formulation and example formulations in accordance with embodiments described herein in a strain jig.

### DETAILED DESCRIPTION

Reference will now be made in detail to various embodiments of polymer blends, specifically polymer blends comprising greater than or equal to 55 wt % and less than or equal to 90 wt % of an aliphatic polyketone; and greater than or equal to 10 wt % and less than or equal to 40 wt % of an acrylonitrile butadiene styrene (ABS), wherein the aliphatic polyketone has a melt flow rate greater than or equal to 1 g/10 min and less than or equal to 90 g/10 min as measured in accordance with ASTM D1238 at 240° C. and a weight of 2.16 kg.

The disclosure should not be construed as limited to the embodiments set forth herein. Rather, these embodiments are provided so that this disclosure will be thorough and complete, and will fully convey the subject matter to those skilled in the art.

### Definitions

Unless otherwise defined, all technical and scientific terms used herein have the same meaning as commonly understood by one of ordinary skill in the art. The terminology used in the disclosure herein is for describing particular embodiments only and is not intended to be limiting.

Ranges may be expressed herein as from “about” one particular value, and/or to “about” another particular value. When such a range is expressed, another embodiment includes from the one particular value and/or to the other particular value. Similarly, when values are expressed as approximations, by use of the antecedent “about,” it will be understood that the particular value forms another embodiment. It will be further understood that the endpoints of each of the ranges are significant both in relation to the other endpoint, and independently of the other endpoint.

Unless otherwise expressly stated, it is in no way intended that any method set forth herein be construed as requiring that its steps be performed in a specific order, nor that with any apparatus specific orientations be required. Accordingly, where a method claim does not actually recite an order to be followed by its steps, or that any apparatus claim does not actually recite an order or orientation to individual components, or it is not otherwise specifically stated in the claims or description that the steps are to be limited to a specific order, or that a specific order or orientation to components of an apparatus is not recited, it is in no way intended that an order or orientation be inferred, in any respect. This holds for any possible non-express basis for interpretation, including: matters of logic with respect to arrangement of steps, operational flow, order of components, or orientation of components; plain meaning derived from grammatical organization or punctuation, and; the number or type of embodiments described in the specification.

As used in the specification and the appended claims, the singular forms “a,” “an,” and “the” are intended to include the plural forms as well, unless the context clearly indicates otherwise. Thus, for example, reference to “a” component includes aspects having two or more such components, unless the context clearly indicates otherwise.

The terms “0 wt %,” “free,” and “substantially free,” when used to describe the weight and/or absence of a particular component in a polymer blend means that the component is not intentionally added to the polymer blend. However, the polymer blend may contain traces of the component as a contaminant or tramp in amounts less than 0.05 wt %.

Weight Average Molecular Weight (Mw), as described herein, is measured using conventional gel permeation chromatography.

The term “wt %,” as described herein, refers to wt % based on the weight of the polymer blend, unless otherwise noted.

The term “heat deflection temperature,” as described herein, refers to the temperature at which an article formed from the polymer blend described herein deflects as measured according to ASTM D648 at a 0.45 MPa load.

The terms “tensile modulus” or “tensile stiffness,” as described herein, refer to the ratio of the stress along an axis over the strain along that axis as measured according to ASTM D638 at 23° C. and a rate of strain of 0.85 mm/s.

The term “yield,” as used herein, refers to the point on a stress-strain curve that indicates the limit of elastic behavior and the beginning of plastic behavior.

The term “tensile strength at yield,” as described herein, refers to the maximum stress that a material can withstand while being stretched before it begins to change shape permanently as measured according to ASTM D638 at 23° C. and a rate of strain of 0.85 mm/s.

The term “tensile elongation at yield,” as described herein, refers to the ratio between the increased length and initial length at the yield point as measured according to ASTM D638 at 23° C. and a rate of strain of 0.85 mm/s.

The term “tensile strength at break,” as described herein, refers to the maximum stress that a material can withstand while stretching before breaking as measured according to ASTM D638 at 23° C. and a rate of strain of 0.85 mm/s.

The term “tensile elongation at break,” as described herein, refers to the ratio between increased length and initial length after breakage as measured according to ASTM D638 at 23° C. and a rate of strain of 0.85 mm/s.

The terms “flexural modulus” or “flexural stiffness,” as described herein, refer the ratio of stress to strain in flexural deformation as measured according to ASTM D790 at 23° C. and a rate of strain 0.21 mm/s.

The term “flexural strength,” as described herein, refers to the maximum bending stress that may be applied to a material before it yields as measured according to ASTM D790 at 23° C. and a rate of strain 0.21 mm/s.

The term “sufficient tensile and flexural strength and stiffness,” as described herein, refers to a tensile modulus greater than or equal to 1100 MPa, a tensile strength at yield greater than or equal to 35 MPa, a tensile elongation at yield greater than or equal to 8%, a tensile strength at break greater than or equal to 35 MPa, a tensile elongation at break greater than or equal to 8%, a flexural modulus greater than or equal to 1200 MPa, and a flexural strength greater than or equal to 45 MPa.

The term “melt flow rate,” as described herein, refers the ability of the material's melt to flow under pressure as measured according to ASTM D1238 at the given temperature and pressure applied by the given weight.

The term “Notched Izod Impact strength,” as described herein, refers to the kinetic energy needed to initiate fracture and continue the fracture until an article formed from the polymer blend described herein is broken as measured according to ASTM D256 at 23° C. and 2.75 J.

The term “specific gravity,” as described herein, refers to the ratio of the density of a material to the density of water and is measured according to ASTM D792 at 23° C.

The term “particle size distribution D50,” as described herein, means that 50% of the particles have diameters below the given size.

The term “Shore D Hardness,” as described herein, refers to the hardness of a material as measured in accordance with ASTM D2240.

The term “acid value,” as described herein, refers to the mass of potassium hydroxide (KOH) in milligrams (mg) that is required to neutralize one gram of a chemical substance as measured in accordance ASTM D3644.

The term “glass transition temperature,” as described herein, refers to the temperature region where the polymer transitions from a hard, glassy material to a soft, rubbery material as measured by dynamic mechanical analysis in accordance with ASTM D4440.

The amount (wt %) of P₂O₅ and CaO in the hydroxyapatite stabilizer is determined by X-ray fluorescence (XRF).

The term “loss on ignition,” as described herein, refers to the mass loss of a combustion residue whenever it is heated in an air/oxygen atmosphere to 800° C. as measured in accordance with ASTM D7348.

As stated above, conventional ABS and PC blends provide the heat resistance and tensile stiffness (i.e., heat deflection temperature of about 90° C. and tensile modulus of about 2700 MPa) necessary for a broad range of applications, including healthcare, automotive, and electronic applications. PC is a stiff, amorphous thermoplastic that imparts heat resistance to the polymer blend. ABS is also an amorphous thermoplastic, but has a lower tensile and flexural stiffness than PC. Accordingly, ABS reduces the tensile and flexural stiffness, thereby improving flexibility, and improves the processability of conventional ABS and PC blends. However, conventional ABS and PC blends have relatively low chemical resistance, particularly towards organic solvents, hydrocarbons, and select alcohols, and may not be sufficient for certain applications in the healthcare, automotive, and electronic fields.

Disclosed herein are polymer blends which mitigate the aforementioned problems. Specifically, the polymer blends disclosed herein comprise a blend of aliphatic polyketone and ABS, which results in a chemically resistant polymer blend having improved heat resistance and sufficient tensile and flexural strength and stiffness. Aliphatic polyketone is a semicrystalline thermoplastic that, similar to PC, increases the heat resistance of the polymer blend. Contrary to its function in conventional ABS and PC blends, ABS imparts tensile and flexural stiffness to the aliphatic polyketone and ABS blend. While not wishing to be bound by theory, it is believed that the resistance of the aliphatic polyketone to non-aqueous solutions and the resistance of the ABS to aqueous solutions results in the overall improved chemical resistance of the aliphatic polyketone and ABS polymer blend. Additionally, it is believed that the semicrystalline structure of aliphatic polyketone results in improved chemical resistance as compared to the amorphous structure of PC. Furthermore, with the addition of a rubber-containing impact modifier, the chemically resistant aliphatic polyketone and ABS polymer blends may exhibit improved impact strength.

The polymer blends disclosed herein may generally be described as comprising an aliphatic polyketone and an acrylonitrile butadiene styrene (ABS).

Aliphatic Polyketone

As described hereinabove, aliphatic polyketone increases the heat resistance of the polymer blend. The combination of aliphatic polyketone and ABS results in a polymer blend with improved chemical resistance as compared to conventional ABS and PC blends. While not wishing to be bound by theory, it is believed that this improved chemical resistance results from the resistance of the aliphatic polyketone to non-aqueous solutions and the resistance of the ABS to aqueous solutions. Additionally, it is believed that the semicrystalline structure of aliphatic polyketone results in improved chemical resistance as compared to the amorphous structure of PC.

Accordingly, in embodiments, aliphatic polyketone is included in amounts greater than or equal to 55 wt % such that the aliphatic polyketone may increase the heat resistance and elongation at yield and contribute to the overall chemical resistance of the polymer blend. In embodiments, the amount of aliphatic polyketone may be limited (e.g., less than or equal to 90 wt %) and balanced with the ABS such that the tensile and flexural stiffness of the polymer blend are not reduced below a desired amount (e.g., greater than or equal to 1100 MPa and greater than or equal to 1200 MPa, respectively) due to the presence of the aliphatic polyketone. In embodiments, the amount of aliphatic polyketone in the polymer blend may be greater than or equal to 55 wt %, greater than or equal to 60 wt %, greater than or equal to 65 wt %, or even greater than or equal to 68 wt %. In embodiments, the amount of aliphatic polyketone may be less than or equal to 90 wt %, less than or equal to 85 wt %, less than or equal to 80 wt %, less than or equal to 75 wt %, or even less than or equal to 70 wt %. In embodiments, the amount of aliphatic polyketone in the polymer blend may be greater than or equal to 55 wt % and less than or equal to 90 wt %, greater than or equal to 55 wt % and less than or equal to 85 wt %, greater than or equal to 55 wt % and less than or equal to 80 wt %, greater than or equal to 55 wt % and less than or equal to 75 wt %, greater than or equal to 55 wt % and less than or equal to 70 wt %, greater than or equal to 60 wt % and less than or equal to 90 wt %, greater than or equal to 60 wt % and less than or equal to 85 wt %, greater than or equal to 60 wt % and less than or equal to 80 wt %, greater than or equal to 60 wt % and less than or equal to 75 wt %, greater than or equal to 60 wt % and less than or equal to 70 wt %, greater than or equal to 65 wt % and less than or equal to 90 wt %, greater than or equal to 65 wt % and less than or equal to 85 wt %, greater than or equal to 65 wt % and less than or equal to 80 wt %, greater than or equal to 65 wt % and less than or equal to 75 wt %, greater than or equal to 65 wt % and less than or equal to 70 wt %, greater than or equal to 68 wt % and less than or equal to 90 wt %, greater than or equal to 68 wt % and less than or equal to 85 wt %, greater than or equal to 68 wt % and less than or equal to 80 wt %, greater than or equal to 68 wt % and less than or equal to 75 wt %, or even greater than or equal to 68 wt % and less than or equal to 70 wt %, or any and all sub-ranges formed from any of these endpoints.

In embodiments, the aliphatic polyketone may have a melt flow rate greater than or equal to 1 g/10 min, greater than or equal to 10 g/10 min, greater than or equal to 20 g/10 min, greater than or equal to 30 g/10 min, or even greater than or equal to 40 g/10 min as measured in accordance with ASTM D1238 at 240° C. and a weight of 2.16 kg. While not wishing to be bound by theory, although an aliphatic polyketone with a higher melt flow rate (e.g., greater than 90 g/10 min) improves the flow of the polymer blend, a higher melt flow rate aliphatic polyketone may not adequately disperse the ABS, which may negatively affect the chemical resistance and impact strength of the polymer blend. Accordingly, in embodiments, the aliphatic polyketone may have a melt flow rate less than or equal to 90 g/10 min, less than or equal to 80 g/10 min, less than or equal to 60 g/10 min, less than or equal to 40 g/10 min, or even less than or equal to 20 g/10 min as measured in accordance with ASTM D1238 at 240° C. and a weight of 2.16 kg. In embodiments, the aliphatic polyketone may have a melt flow rate greater than or equal to 1 g/10 min and less than or equal to 90 g/10 min, greater than or equal to 1 g/10 min and less than or equal to 80 g/10 min, greater than or equal to 1 g/10 min and less than or equal to 60 g/10 min, greater than or equal to 1 g/10 min and less than or equal to 40 g/10 min, greater than or equal to 1 g/10 min and less than or equal to 20 g/10 min, greater than or equal to 10 g/10 min and less than or equal to 90 g/10 min, greater than or equal to 10 g/10 min and less than or equal to 80 g/10 min, greater than or equal to 10 g/10 min and less than or equal to 60 g/10 min, greater than or equal to 10 g/10 min and less than or equal to 40 g/10 min, greater than or equal to 10 g/10 min and less than or equal to 20 g/10 min, greater than or equal to 20 g/10 min and less than or equal to 90 g/10 min, greater than or equal to 20 g/10 min and less than or equal to 80 g/10 min, greater than or equal to 20 g/10 min and less than or equal to 60 g/10 min, greater than or equal to 20 g/10 min and less than or equal to 40 g/10 min, greater than or equal to 30 g/10 min and less than or equal to 90 g/10 min, greater than or equal to 30 g/10 min and less than or equal to 80 g/10 min, greater than or equal to 30 g/10 min and less than or equal to 60 g/10 min, greater than or equal to 30 g/10 min and less than or equal to 40 g/10 min, greater than or equal to 40 g/10 min and less than or equal to 90 g/10 min, greater than or equal to 40 g/10 min and less than or equal to 80 g/10 min, or even greater than or equal to 40 g/10 min and less than or equal to 60 g/10 min, or any and all sub-ranges formed from any of these endpoints as measured in accordance with ASTM D1238 at 240° C. and a weight of 2.16 kg. In embodiments, the aliphatic polyketone may include at least 2 different aliphatic polyketones (e.g., one with a relatively high melt flow rate and one with a relatively low melt flow rate) to achieve an intermediate melt flow rate (e.g., greater than or equal to 60 g/10 min).

In embodiments, the aliphatic polyketone may have a heat deflection temperature greater than or equal to 180° C. or even greater than or equal to 190° C. In embodiments, the aliphatic polyketone may have a heat deflection temperature less than or equal to 225° C. or even less than or equal to 210° C. In embodiments, the aliphatic polyketone may have a heat deflection temperature greater than or equal to 180° C. and less than or equal to 225° C., greater than or equal to 180° C. and less than or equal to 210° C., greater than or equal to 190° C. and less than or equal to 225° C., or even greater than or equal to 190° C. and less than or equal to 210° C., or any and all sub-ranges formed from any of these endpoints.

In embodiments, the aliphatic polyketone may have a tensile modulus greater than or equal to 1300 MPa or even greater than or equal to 1400 MPa. In embodiments, the aliphatic polyketone may have a tensile modulus less than or equal to 1800 MPa or even less than or equal to 1700 MPa. In embodiments, the aliphatic polyketone may have a tensile modulus greater than or equal to 1300 MPa and less than or equal to 1800 MPa, greater than or equal to 1300 MPa and less than or equal to 1700 MPa, greater than or equal to 1400 MPa and less than or equal to 1800 MPa, or even greater than or equal to 1400 MPa and less than or equal to 1700 MPa, or any and all sub-ranges formed from any of these endpoints.

In embodiments, the aliphatic polyketone may have a tensile strength at yield greater than or equal to 45 MPa or even greater than or equal to 55 MPa. In embodiments, the aliphatic polyketone may have a tensile strength at yield less than or equal to 75 MPa or even less than or equal to 65 MPa. In embodiments, the aliphatic polyketone may have a tensile strength at yield greater than or equal to 45 MPa and less than or equal to 75 MPa, greater than or equal to 45 MPa and less than or equal to 65 MPa, greater than or equal to 55 MPa and less than or equal to 75 MPa, or even greater than or equal to 55 MPa and less than or equal to 65 MPa, or any and all sub-ranges formed from any of these endpoints.

In embodiments, the aliphatic polyketone may have a tensile elongation at yield greater than or equal to 15% or even greater than or equal to 20%. In embodiments, the aliphatic polyketone may have a tensile elongation at yield less than or equal to 30% or even less than or equal to 25%. In embodiments, the aliphatic polyketone may have a tensile elongation at yield greater than or equal to 15% and less than or equal to 30%, greater than or equal to 15% and less than or equal to 25%, greater than or equal to 20% and less than or equal to 30%, or even greater than or equal to 20% and less than or equal to 25%, or any and all sub-ranges formed from any of these endpoints.

In embodiments, the aliphatic polyketone may have a flexural modulus greater than or equal to 1200 MPa or even greater than or equal to 1300 MPa. In embodiments, the aliphatic polyketone may have a flexural modulus less than or equal to 1700 MPa or even less than or equal to 1600 MPa. In embodiments, the aliphatic polyketone may have a flexural modulus greater than or equal to 1200 MPa and less than or equal to 1700 MPa, greater than or equal to 1200 MPa and less than or equal to 1600 MPa, greater than or equal to 1300 MPa and less than or equal to 1700 MPa, or even greater than or equal to 1300 MPa and less than or equal to 1600 MPa, or any and all sub-ranges formed from any of these endpoints.

In embodiments, the aliphatic polyketone may have a flexural strength greater than or equal to 40 MPa or even greater than or equal to 50 MPa. In embodiments, the aliphatic polyketone may have a flexural strength less than or equal to 70 MPa or even less than or equal to 60 MPa. In embodiments, the aliphatic polyketone may have a flexural strength greater than or equal to 40 MPa and less than or equal to 70 MPa, greater than or equal to 40 MPa and less than or equal to 60 MPa, greater than or equal to 50 MPa and less than or equal to 70 MPa, or even greater than or equal to 50 MPa and less than or equal to 60 MPa, or any and all sub-ranges formed from any of these endpoints.

In embodiments, the aliphatic polyketone may have a Notched Izod Impact strength greater than or equal to 75 J/m, greater than or equal to 100 J/m, greater than or equal to 150 J/m, or even greater than or equal to 200 J/m. In embodiments, the aliphatic polyketone may have a Notched Izod Impact strength less than or equal to 250 J/m or even less than or equal to 225 J/m. In embodiments, the aliphatic polyketone may have a Notched Izod Impact strength greater than or equal to 75 J/m and less than or equal to 250 J/m, greater than or equal to 75 J/m and less than or equal to 225 J/m, greater than or equal to 100 J/m and less than or equal to 250 J/m, greater than or equal to 100 J/m and less than or equal to 225 J/m, greater than or equal to 150 J/m and less than or equal to 250 J/m, greater than or equal to 150 J/m and less than or equal to 225 J/m, greater than or equal to 200 J/m and less than or equal to 250 J/m, or even greater than or equal to 200 J/m and less than or equal to 225 J/m, or any and all sub-ranges formed from any of these endpoints.

In embodiments, the aliphatic polyketone may have a specific gravity greater than or equal to 1.15 or even greater than or equal to 1.2. In embodiments, the aliphatic polyketone may have a specific gravity less than or equal to 1.3 or even less than or equal to 1.25. In embodiments, the aliphatic polyketone may have a specific gravity greater than or equal to 1.15 and less than or equal to 1.3, greater than or equal to 1.15 and less than or equal to 1.25, greater than or equal to 1.2 and less than or equal to 1.3, or even greater than or equal to 1.2 and less than or equal to 1.25, or any and all sub-ranges formed from any of these endpoints.

Suitable commercial embodiments of the aliphatic polyketone are available under the POKETONE brand from Hyosung, such as grades M330, M630, and M930 containing various additives as denoted by “A,” “F,” “S,” or others, or containing no additives as designated by “P.” The polymer blends described herein may include a powdered grade of aliphatic polyketone, such as POKETONE M630P, in addition to another grade of aliphatic polyketone, such as POKETONE M630A, to ensure easier dosing of the additional components of the blends. Table 1 shows certain properties of POKETONE M330A, M630A, and M930A.

TABLE 1

| | POKETONE M330A | POKETONE M630A | POKETONE M930A |
|---|---|---|---|
| Melt flow rate (g/10 min) | 60 | 6 | 200 |
| (240° C./2.16 kg) | | | |
| Heat deflection temp (° C.) | 200 | 195 | 105 |
| Tensile modulus (MPa) | 1600 | 1450 | — |
| Tensile strength at yield (MPa) | 60 | 58 | 62 |
| Tensile elongation at yield (%) | 21 | 22 | — |
| Tensile elongation at break (%) | 300 | 300 | 130 |
| Flexural modulus (MPa) | 1500 | 1350 | 1600 |
| Flexural strength (MPa) | 57 | 53 | 60 |
| Notched Izod impact strength | 95 | 220 | — |
| (J/m) | | | |
| Specific gravity | 1.24 | 1.24 | 1.24 |

Acrylonitrile Butadiene Styrene (ABS)

As stated above, ABS increases the tensile and flexural stiffness of the polymer blend, and the combination of ABS and aliphatic polyketone results in a polymer blend with improved chemical resistance as compared to conventional ABS and PC blends. While not wishing to be bound by theory, it is believed that this improved chemical resistance results from the resistance of the aliphatic polyketone to non-aqueous solutions and the resistance of the ABS to aqueous solutions.

Accordingly, in embodiments, ABS is included in amounts greater than or equal to 10 wt % such that the ABS may increase the tensile and flexural stiffness and contribute to the overall chemical resistance of the polymer blend. In embodiments, the amount of ABS may be limited (e.g., less than or equal to 40 wt %) such that the heat resistance is not reduced below a desired amount (e.g., heat deflection temperature greater than or equal to 100° C.) due to the presence of ABS. In embodiments, the amount of ABS in the polymer blend may be greater than or equal to 10 wt %, greater than or equal to 14 wt %, greater than or equal to 18 wt %, greater than or equal to 20 wt %, greater than or equal to 24 wt %, or even greater than or equal to 28 wt %. In embodiments, the amount of ABS in the polymer blend may be less than or equal to 40 wt %, less than or equal to 35 wt %, or even less than or equal to 30 wt %. In embodiments, the amount of ABS in the polymer blend may be greater than or equal to 10 wt % and less than or equal to 40 wt %, greater than or equal to 10 wt % and less than or equal to 35 wt %, greater than or equal to 10 wt % and less than or equal to 30 wt %, greater than or equal to 14 wt % and less than or equal to 40 wt %, greater than or equal to 14 wt % and less than or equal to 35 wt %, greater than or equal to 14 wt % and less than or equal to 30 wt %, greater than or equal to 18 wt % and less than or equal to 40 wt %, greater than or equal to 18 wt % and less than or equal to 35 wt %, greater than or equal to 18 wt % and less than or equal to 30 wt %, greater than or equal to 20 wt % and less than or equal to 40 wt %, greater than or equal to 20 wt % and less than or equal to 35 wt %, greater than or equal to 20 wt % and less than or equal to 30 wt %, greater than or equal to 24 wt % and less than or equal to 40 wt %, greater than or equal to 24 wt % and less than or equal to 35 wt %, greater than or equal to 24 wt % and less than or equal to 30 wt %, greater than or equal to 28 wt % and less than or equal to 40 wt %, greater than or equal to 28 wt % and less than or equal to 35 wt %, or even greater than or equal to 28 wt % and less than or equal to 30 wt %, or any and all sub-ranges formed from any of these endpoints.

In embodiments, the ABS may comprise an emulsion ABS produced via an emulsion polymerization process. In embodiments, the ABS may comprise bulk ABS, a purer ABS produced with minimal additives by mass polymerization.

In embodiments, the ABS may have a melt flow rate greater than or equal to 1 g/10 min, greater than or equal to 3 g/10 min, or even greater than or equal to 5 g/10 min as measured in accordance with ASTM D1238 at 230° C. and a weight of 3.8 kg. In embodiments, the ABS may have a melt flow rate less than or equal to 20 g/10 min or even less than or equal to 10 g/10 min as measured in accordance with ASTM D1238 at 230° C. and a weight of 3.8 kg. In embodiments, the ABS may have a melt flow rate greater than or equal to 1 g/10 min and less than or equal to 20 g/10 min, greater than or equal to 1 g/10 min and less than or equal to 10 g/10 min, greater than or equal to 3 g/10 min and less than or equal to 20 g/10 min, greater than or equal to 3 g/10 min and less than or equal to 10 g/10 min, greater than or equal to 5 g/10 min and less than or equal to 20 g/10 min, or even greater than or equal to 5 g/10 min and less than or equal to 10 g/10 min, or any and all sub-ranges formed from any of these endpoints as measured in accordance with ASTM D1238 at 230° C. and a weight of 3.8 kg.

In embodiments, the ABS may have a tensile modulus greater than or equal to 2000 MPa or even greater than or equal to 2500 MPa. In embodiments, the ABS may have a tensile modulus less than or equal to 3500 MPa or even less than or equal to 3000 MPa. In embodiments, the ABS may have a tensile modulus greater than or equal to 2000 MPa and less than or equal to 3500 MPa, greater than or equal to 2000 MPa and less than or equal to 3000 MPa, greater than or equal to 2500 MPa and less than or equal to 3500 MPa, or even greater than or equal to 2500 MPa and less than or equal to 3000 MPa, or any and all sub-ranges formed from any of these endpoints.

In embodiments, the ABS may have a tensile strength at yield greater than or equal to 30 MPa, greater than or equal to 35 MPa, or even greater than or equal to 40 MPa. In embodiments, the ABS may have a tensile strength at yield less than or equal to 50 MPa or even less than or equal to 45 MPa. In embodiments, the ABS may have a tensile strength at yield greater than or equal to 30 MPa and less than or equal to 50 MPa, greater than or equal to 30 MPa and less than or equal to 45 MPa, greater than or equal to 35 MPa and less than or equal to 50 MPa, greater than or equal to 35 MPa and less than or equal to 45 MPa, greater than or equal to 40 MPa and less than or equal to 50 MPa, or even greater than or equal to 40 MPa and less than or equal to 45 MPa, or any and all sub-ranges formed from any of these endpoints.

In embodiments, the ABS may have a tensile elongation at yield greater than or equal to 1% or even greater than or equal to 1.5%. In embodiments, the ABS may have a tensile elongation at yield less than or equal to 5% or even less than or equal to 4%. In embodiments, the ABS may have a tensile elongation at yield greater than or equal to 1% and less than or equal to 5%, greater than or equal to 1% and less than or equal to 4%, greater than or equal to 1.5% and less than or equal to 5%, or even greater than or equal to 1.5% and less than or equal to 4%, or any and all sub-ranges formed from any of these endpoints.

In embodiments, the ABS may have a tensile elongation at break greater than or equal to 5% or even greater than or equal to 10%. In embodiments, the ABS may have a tensile elongation at break less than or equal to 40% or even less than or equal to 35%. In embodiments, the ABS may have a tensile elongation at break greater than or equal to 5% and less than or equal to 40%, greater than or equal to 5% and less than or equal to 35%, greater than or equal to 10% and less than or equal to 40%, or even greater than or equal to 10% and less than or equal to 35%, or any and all sub-ranges from any of these endpoints.

In embodiments, the ABS may have a flexural modulus greater than or equal to 2400 MPa or even greater than or equal to 2500 MPa. In embodiments, the ABS may have a flexural modulus less than or equal to 2800 MPa or even less than or equal to 2700 MPa. In embodiments, the ABS may have a flexural modulus greater than or equal to 2400 MPa and less than or equal to 2800 MPa, greater than or equal to 2400 MPa and less than or equal to 2700 MPa, greater than or equal to 2500 MPa and less than or equal to 2800 MPa, or even greater than or equal to 2500 MPa and less than or equal to 2700 MPa, or any and all sub-ranges formed from any of these endpoints.

In embodiments, the ABS may have a flexural strength greater than or equal to 60 MPa or even greater than or equal to 70 MPa. In embodiments, the ABS may have a flexural strength less than or equal to 90 MPa or even less than or equal to 80 MPa. In embodiments, the ABS may have a flexural strength greater than or equal to 60 MPa and less than or equal to 90 MPa, greater than or equal to 60 MPa and less than or equal to 80 MPa, greater than or equal to 70 MPa and less than or equal to 90 MPa, or even greater than or equal to 70 MPa and less than or equal to 80 MPa, or any and all sub-ranges formed from any of these endpoints.

In embodiments, the ABS may have a Notched Izod Impact strength greater than or equal to 200 J/m, greater than or equal to 300 J/m, or even greater than or equal to 350 J/m. In embodiments, the ABS may have a Notched Izod Impact strength less than or equal to 500 J/m or even less than or equal to 400 J/m. In embodiments, the ABS may have a Notched Izod Impact strength greater than or equal to 250 J/m and less than or equal to 500 J/m, greater than or equal to 250 J/m and less than or equal to 400 J/m, greater than or equal to 300 J/m and less than or equal to 500 J/m, greater than or equal to 300 J/m and less than or equal to 400 J/m, greater than or equal to 350 J/m and less than or equal to 500 J/m, or even greater than or equal to 350 J/m and less than or equal to 400 J/m, or any and all sub-ranges formed from any of these endpoints.

Suitable commercial embodiments of the ABS are available under the LUSTRAN brand from INEOS Styrolution, such as grades 348 and 433, and under the MAGNUM brand from Trinseo, such as grade 8391 MED. Table 2 shows certain properties of LUSTRAN 348 and 433 and MAGNUM 8391 MED

TABLE 2

| | | | MAGNUM 8391 |
|---|---|---|---|
| | LUSTRAN 348 | LUSTRAN 433 | MED |
| Melt flow rate (g/10 min) | 5 | 3.6 | 8 |
| (230° C./3.8 kg) | | | |
| Tensile modulus (MPa) | 2600 | 2551 | 2340 |
| Tensile strength at yield (MPa) | 48 | 42 | 48 |
| Tensile elongation at break (%) | 25 | 30 | 8.7 |
| Flexural modulus (MPa) | 2700 | 2620 | 2480 |
| Flexural strength (MPa) | 76 | 72 | 75 |
| Notched Izod Impact strength | 214 | 374 | 230 |
| (J/m) | | | |

Polymer Blend

As described hereinabove, aliphatic polyketone increases the heat resistance of the polymer blend, but may decrease the tensile and flexural stiffness of the polymer blend. While ABS increases the tensile and flexural stiffness of the polymer blend, ABS may decrease the heat resistance of the polymer blend. Accordingly, in achieving a polymer blend having an improved chemical resistance, the amount of aliphatic polyketone should be balanced with the amount of ABS to maintain improved heat resistance and achieve the desired tensile and flexural stiffness. In embodiments, the ratio by weight of aliphatic polyketone to ABS may be from 2:1 to 6:1, from 2:1 to 5:1, from 2:1 to 4:1, from 2:1 to 3:1, from 2:1 to 2.5:1, from 2:1 to 2.3:1, from 2.3:1 to 6:1, from 2.3:1 to 5:1, from 2.3:1 to 4:1, from 2.3:1 to 3:1, from 2.3:1 to 2.5:1, from 2.5:1 to 6:1, from 2.5:1 to 5:1, from 2.5:1 to 4:1, from 2.5:1 to 3:1, from 3:1 to 6:1, from 3:1 to 5:1, from 3:1 to 4:1, from 4:1 to 6:1, from 4:1 to 5:1, or even from 5:1 to 6:1, or any and all sub-ranges formed from any of these endpoints.

Aliphatic polyketones increase the heat resistance of the polymer blend as evidenced by the heat deflection temperature of the polymer blend. A higher heat deflection temperature indicates an increase in the polymer blend's ability to resist distortion under a given load at an elevated temperature. Certain applications may require heat deflection temperatures (e.g., greater than or equal to 100° C.). In embodiments, the polymer blend may have a heat deflection temperature greater than or equal to 100° C. or even greater than or equal to 110° C. In embodiments, the polymer blend may have a heat deflection temperature less than or equal to 175° C., less than or equal to 150° C., or even less than or equal to 125° C. In embodiments, the polymer blend may have a heat deflection temperature greater than or equal to 100° C. and less than or equal to 175° C., greater than or equal to 100° C. and less than or equal to 150° C., greater than or equal to 100° C. and less than or equal to 125° C., greater than or equal to 110° C. and less than or equal to 175° C., greater than or equal to 110° C. and less than or equal to 150° C., or even greater than or equal to 110° C. and less than or equal to 125° C., or any and all sub-ranges formed from any of these endpoints.

ABS increases the tensile and flexural stiffness of the polymer blend as evidenced by the tensile modulus of the polymer blend. A higher tensile and flexural modulus indicates an increased stiffness and, thus, correlates to a stronger polymer blend. In embodiments, the polymer blend may have a tensile modulus greater than or equal to 1100 MPa, greater than or equal to 1250, greater than or equal to 1500 MPa or even greater than or equal to 1600 MPa. In embodiments, the polymer blend may have a tensile modulus less than or equal to 2500 MPa, less than or equal to 2000 MPa, or even less than or equal to 1800 MPa. In embodiments, the polymer blend may have a tensile modulus greater than or equal to 1100 MPa and less than or equal to 2500 MPa, greater than or equal to 1100 MPa and less than or equal to 2000 MPa, greater than or equal to 1100 MPa and less than or equal to 1800 MPa, greater than or equal to 1250 MPa and less than or equal to 2500 MPa, greater than or equal to 1250 MPa and less than or equal to 2000 MPa, greater than or equal to 1250 MPa and less than or equal to 1800 MPa, greater than or equal to 1500 MPa and less than or equal to 2500 MPa, greater than or equal to 1500 MPa and less than or equal to 2000 MPa, greater than or equal to 1500 MPa and less than or equal to 1800 MPa, greater than or equal to 1600 MPa and less than or equal to 2500 MPa, greater than or equal to 1600 MPa and less than or equal to 2000 MPa, or even greater than or equal to 1600 MPa and less than or equal to 1800 MPa, or any and all sub-ranges formed from any of these endpoints. In embodiments, the polymer blend may have a flexural modulus greater than or equal to 1200 MPa or even greater than or equal to 1300 MPa. In embodiments, the polymer blend may have a flexural modulus less than or equal to 2500 MPa, less than or equal to 2250 MPa, or even less than or equal to 2000 MPa. In embodiments, the polymer blend may have a flexural modulus greater than or equal to 1200 MPa and less than or equal to 2500 MPa, greater than or equal to 1200 MPa and less than or equal to 2250 MPa, greater than or equal to 1200 MPa and less than or equal to 2000 MPa, greater than or equal to 1300 MPa and less than or equal to 2500 MPa, greater than or equal to 1300 MPa and less than or equal to 2250 MPa, or even greater than or equal to 1300 MPa and less than or equal to 2000 MPa, or any and all sub-ranges formed from any of these endpoints

In embodiments, the polymer blend may have a tensile strength at yield greater than or equal to 35 MPa, greater than or equal to 40 MPa, or even greater than or equal to 42 MPa. In embodiments, the polymer blend may have a tensile strength at yield less than or equal to 65 MPa, less than or equal to 60 MPa, less than or equal to 55 MPa, less than or equal to 50 MPa, or even less than or equal to 48 MPa. In embodiments, the polymer blend may have a tensile strength at yield greater than or equal to 35 MPa and less than or equal to 65 MPa, greater than or equal to 35 MPa and less than or equal to 60 MPa, greater than or equal to 35 MPa and less than or equal to 55 MPa, greater than or equal to 35 MPa and less than or equal to 50 MPa, greater than or equal to 35 MPa and less than or equal to 48 MPa, greater than or equal to 40 MPa and less than or equal to 65 MPa, greater than or equal to 40 MPa and less than or equal to 60 MPa, greater than or equal to 40 MPa and less than or equal to 55 MPa, greater than or equal to 40 MPa and less than or equal to 50 MPa, greater than or equal to 40 MPa and less than or equal to 48 MPa, greater than or equal to 42 MPa and less than or equal to 65 MPa, greater than or equal to 42 MPa and less than or equal to 60 MPa, greater than or equal to 42 MPa and less than or equal to 55 MPa, greater than or equal to 42 MPa and less than or equal to 50 MPa, or even greater than or equal to 42 MPa and less than or equal to 48 MPa, or any and all sub-ranges formed from any of these endpoints.

In embodiments, the polymer blend may have a tensile elongation at yield greater than or equal to 8%, greater than or equal to 10%, or even greater than or equal to 12%. In embodiments, the polymer blend may have a tensile elongation at yield less than or equal to 30%, less than or equal to 25%, less than or equal to 20%, or even less than or equal to 18%. In embodiments, the polymer blend have a tensile elongation at yield greater than or equal to 8% and less than or equal to 30%, greater than or equal to 8% and less than or equal to 25%, greater than or equal to 8% and less than or equal to 20%, greater than or 8% and less than or equal to 18%, greater than or equal to 10% and less than or equal to 30%, greater than or equal to 10% and less than or equal to 25%, greater than or equal to 10% and less than or equal to 20%, greater than or equal to 10% and less than or equal to 18%, greater than or equal to 12% and less than or equal to 30%, greater than or equal to 12% and less than or equal to 25%, greater than or equal to 12% and less than or equal to 20%, or even greater than or equal to 12% and less than or equal to 18%, or any and all sub-ranges formed from any of these endpoints. In embodiments, the polymer blend may not exhibit a defined tensile elongation at yield.

In embodiments, the polymer blend may have a tensile strength at break greater than or equal to 35 MPa, greater than or equal to 40 MPa, or even greater than or equal to 42 MPa. In embodiments, the polymer blend may have a tensile strength at break less than or equal to 65 MPa, less than or equal to 60 MPa, less than or equal to 55 MPa, less than or equal to 50 MPa, or even less than or equal to 48 MPa. In embodiments, the polymer blend may have a tensile strength at break greater than or equal to 35 MPa and less than or equal to 65 MPa, greater than or equal to 35 MPa and less than or equal to 60 MPa, greater than or equal to 35 MPa and less than or equal to 55 MPa, greater than or equal to 35 MPa and less than or equal to 50 MPa, greater than or equal to 35 MPa and less than or equal to 48 MPa, greater than or equal to 40 MPa and less than or equal to 65 MPa, greater than or equal to 40 MPa and less than or equal to 60 MPa, greater than or equal to 40 MPa and less than or equal to 55 MPa, greater than or equal to 40 MPa and less than or equal to 50 MPa, greater than or equal to 40 MPa and less than or equal to 48 MPa, greater than or equal to 42 MPa and less than or equal to 65 MPa, greater than or equal to 42 MPa and less than or equal to 60 MPa, greater than or equal to 42 MPa and less than or equal to 55 MPa, greater than or equal to 42 MPa and less than or equal to 50 MPa, or even greater than or equal to 42 MPa and less than or equal to 48 MPa, or any and all sub-ranges formed from any of these endpoints.

In embodiments, the polymer blend may have a tensile elongation at break greater than or equal to 8%, greater than or equal to 15%, or even greater than or equal to 20%. In embodiments, the polymer blend may have a tensile elongation at break less than or equal to 400%, less than or equal to 300%, less than or equal to 200%, or even less than or equal to 100%. In embodiments, the polymer blend may have a tensile elongation at break greater than or equal to 8% and less than or equal to 400%, greater than or equal to 8% and less than or equal to 300%, greater than or equal to 8% and less than or equal to 200%, greater than or equal to 8% and less than or equal to 100%, greater than or equal to 15% and less than or equal to 400%, greater than or equal to 15% and less than or equal to 300%, greater than or equal to 15% and less than or equal to 200%, greater than or equal to 15% and less than or equal to 100%, greater than or equal to 20% and less than or equal to 400%, greater than or equal to 20% and less than or equal to 300%, greater than or equal to 20% and less than or equal to 200%, or even greater than or equal to 20% and less than or equal to 100%, or any and all sub-ranges formed from any of these endpoints.

In embodiments, the polymer blend may have a flexural strength greater than or equal to 45 MPa or even greater than or equal to 50 MPa. In embodiments, the polymer blend may have a flexural strength less than or equal to 85 MPa or even less than or equal to 80 MPa. In embodiments, the polymer blend may have a flexural strength greater than or equal to 45 MPa and less than or equal to 85 MPa, greater than or equal to 45 MPa and less than or equal to 80 MPa, greater than or equal to 50 MPa and less than or equal to 85 MPa, or even greater than or equal to 50 MPa and less than or equal to 80 MPa, or any and all sub-ranges formed from any of these endpoints.

In embodiments, the polymer blend may have a tensile modulus greater than or equal to 1100 MPa, a tensile strength at yield of greater than or equal to 35 MPa, a tensile elongation at yield greater than or equal to 8%, a tensile strength at break greater than or equal to 35 MPa, a tensile elongation at break greater than or equal to 8%, a flexural modulus greater than or equal to 1200 MPa, and a flexural strength greater than or equal to 45 MPa.

As exemplified in the Examples section below, the aliphatic polyketone and ABS blends described herein have improved chemical resistance while providing improved heat resistance and sufficient tensile and flexural strength and stiffness. Accordingly, the aliphatic polyketone and ABS blends may be more suitable for certain applications in the healthcare, automotive, and electronic fields in which chemical resistance is desired.

Hydroxyapatite Stabilizer

In embodiments, the polymer blend may further comprise a hydroxyapatite stabilizer. While not wishing to be bound by theory, without a hydroxyapatite stabilizer present, the aliphatic polyketone may crosslink with itself resulting in significant increases in viscosity and, consequently, processing difficulties. When present in the polymer blend, the hydroxyapatite stabilizer acts as an acid scavenger, which prevents the aliphatic polyketone from self-reaction and crosslinking.

In embodiments, the hydroxyapatite stabilizer may comprise pentacalcium hydroxide tris(orthophosphate), amorphous tricalcium hydroxyphosphate, calcium phosphate hydroxide, or a combination thereof.

In embodiments, the amount of hydroxyapatite stabilizer in the polymer blend may be greater than 0 wt %, greater than or equal to 0.1 wt %, greater than or equal to 0.25 wt %, or even greater than or equal to 0.5 wt %. In embodiments, the amount of hydroxyapatite stabilizer in the polymer blend may be less than or equal to 1 wt % or even less than or equal to 0.75 wt %. In embodiments, the amount of hydroxyapatite stabilizer in the polymer blend may be greater than 0 wt % and less than or equal to 1 wt %, greater than 0 wt % and less than or equal to 0.75 wt %, greater than or equal to 0.25 wt % and less than or equal to 1 wt %, greater than or equal to 0.25 wt % and less than or equal to 0.75 wt %, greater than or equal to 0.5 wt % and less than or equal to 1 wt %, or even greater than or equal to 0.5 wt % and less than or equal to 0.75 wt %, or any and all sub-ranges formed from any of these endpoints.

In embodiments, the amount of P₂O₅ in the hydroxyapatite stabilizer may be greater than or equal to 30 wt % or even greater than or equal to 40 wt %. In embodiments, the amount of P₂O₅ in the hydroxyapatite stabilizer may be less than or equal to 60 wt % or even less than or equal to 50 wt %. In embodiments, the amount of P₂O₅ in the hydroxyapatite stabilizer may be greater than or equal to 30 wt % and less than or equal to 60 wt %, greater than or equal to 30 wt % and less than or equal to 50 wt %, greater than or equal to 40 wt % and less than or equal to 60 wt %, or even greater than or equal to 40 wt % and less than or equal to 50 wt %, or any and all sub-ranges formed from any of these endpoints.

In embodiments, the amount of CaO in the hydroxyapatite stabilizer may be greater than or equal to 40 wt % or even greater than or equal to 50 wt %. In embodiments, the amount of CaO in the hydroxyapatite stabilizer may be less than or equal to 70 wt % or even less than or equal to 60 wt %. In embodiments, the amount of CaO in the hydroxyapatite stabilizer may be greater than or equal to 40 wt % and less than or equal to 70 wt %, greater than or equal to 40 wt % and less than or equal to 60 wt %, greater than or equal to 50 wt % and less than or equal to 70 wt %, or even greater than or equal to 50 wt % and less than or equal to 60 wt %, or any and all sub-ranges formed from any of these endpoints.

In embodiments, the hydroxyapatite stabilizer may have a particle size D50 greater than or equal to 1 μm or even greater than or equal to 2 μm. In embodiments, the hydroxyapatite stabilizer may have a particle size distribution D50 less than or equal to 10 μm or even less than or equal to 5 μm. In embodiments, the hydroxyapatite stabilizer may have a particle size D50 greater than or equal to 1 μm and less than or equal to 10 μm, greater than or equal to 1 μm and less than or equal to 5 μm, greater than or equal to 2 μm and less than or equal to 10 μm, or even greater than or equal to 2 μm and less than or equal to 5 μm, or any and all sub-ranges formed from any of these endpoints

In embodiments, the hydroxyapatite stabilizer may have a loss on ignition greater than or equal to 2% or even greater than or equal to 4%. In embodiments, the hydroxyapatite stabilizer may have a loss on ignition less than or equal to 10% or even less than or equal to 5%. In embodiments, the hydroxyapatite stabilizer may have a loss on ignition greater than or equal to 2% and less than or equal to 10%, greater than or equal to 2% and less than or equal to 5%, greater than or equal to 4% and less than or equal to 10%, or even greater than or equal to 4% and less than or equal to 5%, or any and all sub-ranges formed from any of these endpoints.

Suitable commercial embodiments of the hydroxyapatite stabilizer are available under the as EPSOLUTE brand from Budenheim, such as grade C13-09. Table 3 shows certain properties of EP SOLUTE C13-09.

TABLE 3

| | EPSOLUTE C13-09 |
|---|---|
| P2O5 (wt %) | 40.0-42.0 |
| CaO (wt %) | 53.0-56.0 |
| Particle size (D50) (μm) | 2.9-3.4 |
| Loss on ignition (%) | 4.0 |

Rubber-Containing Impact Modifier

In addition to improved chemical resistance, it may be desirable for the aliphatic polyketone and ABS blends described herein to exhibit improved impact strength, as evidenced by a Notched Izod Impact strength greater than or equal to 400 J/m. For example, impact resistant aliphatic polyketone and ABS blends may be desirable in automotive and industrial applications. Accordingly, in embodiments, a rubber-containing impact modifier may be added to the aliphatic polyketone and ABS blends described herein to increase the Notched Izod Impact strength of the polymer blends.

In embodiments, the amount of rubber-containing impact modifier in the polymer blend may be greater than 0 wt %, greater than or equal to 3 wt %, greater than or equal to 5 wt %, greater than or equal to 7 wt %, or even greater than or equal to 10 wt %. In embodiments, the amount of rubber-containing impact modifier may be less than or equal to 20 wt %, less than or equal to 18 wt %, less than or equal to 16 wt %, less than or equal to 14 wt %, or even less than or equal to 12 wt %. In embodiments, the amount of rubber-containing impact modifier in the polymer blend may be greater 0 wt % and less than or equal to 20 wt %, greater than 0 wt % and less than or equal to 18 wt %, greater than 0 wt % and less than or equal to 16 wt %, greater than 0 wt % and less than or equal to 14 wt %, greater than 0 wt % and less than or equal to 12 wt %, greater than or equal to 3 wt % and less than or equal to 20 wt %, greater than or equal to 3 wt % and less than or equal to 18 wt %, greater than or equal to 3 wt % and less than or equal to 16 wt %, greater than or equal to 3 wt % and less than or equal to 14 wt %, greater than or equal to 3 wt % and less than or equal to 12 wt %, greater than or equal to 5 wt % and less than or equal to 20 wt %, greater than or equal to 5 wt % and less than or equal to 18 wt %, greater than or equal to 5 wt % and less than or equal to 16 wt %, greater than or equal to 5 wt % and less than or equal to 14 wt %, greater than or equal to 5 wt % and less than or equal to 12 wt %, greater than or equal to 7 wt % and less than or equal to 20 wt %, greater than or equal to 7 wt % and less than or equal to 18 wt %, greater than or equal to 7 wt % and less than or equal to 16 wt %, greater than or equal to 7 wt % and less than or equal to 14 wt %, greater than or equal to 7 wt % and less than or equal to 12 wt %, greater than or equal to 10 wt % and less than or equal to 20 wt %, greater than or equal to 10 wt % and less than or equal to 18 wt %, greater than or equal to 10 wt % and less than or equal to 16 wt %, greater than or equal to 10 wt % and less than or equal to 14 wt %, or even greater than or equal to 10 wt % and less than or equal to 12 wt %, or any and all sub-ranges formed from any of these endpoints.

In embodiments, the rubber-containing impact modifier may comprise another ABS, methyl methacrylate butadiene styrene (MBS), acrylonitrile styrene acrylate (ASA), styrene acrylonitrile (SAN), or a combination thereof. In embodiments, the another ABS may be a high rubber (e.g., greater than 50 wt % butadiene) ABS.

In embodiments, the polymer blend may have a Notched Izod Impact strength greater than or equal to 400 J/m, greater than or equal to 450 J/m, greater than or equal to 500 J/m, or even greater than or equal to 550 J/m. In embodiments, the polymer blend may have a Notched Izod Impact strength less than or equal to 1200 J/m, less than or equal to 1100 J/m, or even less than or equal to 1000 J/m. In embodiments, the polymer blend may have a Notched Izod Impact strength greater than or equal to 400 J/m and less than or equal to 1200 J/m, greater than or equal to 400 J/m and less than or equal to 1100 J/m, greater than or equal to 400 J/m and less than or equal to 1000 J/m, greater than or equal to 450 J/m and less than or equal to 1200 J/m, greater than or equal to 450 J/m and less than or equal to 1100 J/m, greater than or equal to 450 J/m and less than or equal to 1000 J/m, greater than or equal to 500 J/m and less than or equal to 1200 J/m, greater than or equal to 500 J/m and less than or equal to 1100 J/m, greater than or equal to 500 J/m and less than or equal to 1000 J/m, greater than or equal to 550 J/m and less than or equal to 1200 J/m, greater than or equal to 550 J/m and less than or equal to 1100 J/m, or even greater than or equal to 550 J/m and less than or equal to 1000 J/m, or any and all sub-ranges formed from any of these endpoints.

In embodiments, the rubber-containing impact modifier may have a melt flow rate greater than or equal to 1 g/10 min, greater than or equal to 3 g/10 min, or even greater than or equal to 5 g/10 min as measured in accordance with ASTM D1238 at 230° C. and a weight of 3.8 kg. In embodiments, the rubber-containing impact modifier may have a melt flow rate less than or equal to 20 g/10 min or even less than or equal to 10 g/10 min as measured in accordance with ASTM D1238 at 230° C. and a weight of 3.8 kg. In embodiments, the rubber-containing impact modifier may have a melt flow rate greater than or equal to 1 g/10 min and less than or equal to 20 g/10 min, greater than or equal to 1 g/10 min and less than or equal to 10 g/10 min, greater than or equal to 3 g/10 min and less than or equal to 20 g/10 min, greater than or equal to 3 g/10 min and less than or equal to 10 g/10 min, greater than or equal to 5 g/10 min and less than or equal to 20 g/10 min, or even greater than or equal to 5 g/10 min and less than or equal to 10 g/10 min, or any and all sub-ranges formed from any of these endpoints as measured in accordance with ASTM D1238 at 230° C. and a weight of 3.8 kg.

In embodiments, the rubber-containing impact modifier may have a specific gravity greater than or equal to 0.85 or even greater than or equal to 0.9. In embodiments, the rubber-containing impact modifier may have a specific gravity less than or equal to 1.05 or even less than or equal to 1. In embodiments the rubber-containing impact modifier may have a specific gravity greater than or equal to 0.85 and less than or equal to 1.05, greater than or equal to 0.85 and less than or equal to 1, greater than or equal to 0.9 and less than or equal to 1.05, or even greater than or equal to 0.9 and less than or equal to 1, or any and all sub-ranges formed from any of these endpoints.

In embodiments, the rubber-containing impact modifier may have a Shore D hardness greater than or equal to 20 or even greater than or equal to 30. In embodiments, the rubber-containing impact modifier may have a Shore D hardness less than or equal to 60 or even less than or equal to 50. In embodiments, the rubber-containing impact modifier may have a Shore D hardness greater than or equal to 20 and less than or equal to 60, greater than or equal to 20 and less than or equal to 50, greater than or equal to 30 and less than or equal to 60, or even greater than or equal to 30 and less than or equal to 50, or any and all sub-ranges formed from any of these endpoints.

Suitable commercial embodiments of the rubber-containing impact modifier are available under the BLENDEX brand from Galata Chemicals, such as grade 338, and under the CLEARSTRENGTH brand from Arkema, such as grade E-920. Table 4 shows certain properties of BLENDEX 338 and CLEARSTRENGTH E-920.

TABLE 4

| | BLENDEX 338 | CLEARSTRENGTH E-920 |
|---|---|---|
| Melt flow rate (g/10 min) | 5.7 | — |
| (230° C./3.8 kg) | | |
| Specific gravity | 0.950 | 1.02 |
| Hardness (Shore D) | 40 | — |

As exemplified in the Examples section below, the addition of a rubber-containing impact modifier to an aliphatic polyketone and ABS blend as described herein results in a polymer blend that exhibits chemical resistance and improved impact strength.

Compatibilizer

In addition to improved chemical resistance, it may be desirable to compatibilize the components of the polymer blend. Accordingly, in embodiments, a compatibilizer may be added to the aliphatic polyketone and ABS blends described herein. The compatibilizer may react with or be miscible with the aliphatic polyketone and/or ABS to alter the dissimilar phases and improve the interfacial compatibility of the polymer blend as evidenced by increased Notched Izod Impact strength and a shift in glass transition temperature determined by dynamic mechanical analysis.

In embodiments, the amount of compatibilizer in the polymer blend may be greater than 0 wt %, greater than or equal to 1 wt %, greater than or equal to 1.25 wt %, greater than or equal to 2 wt %, or even greater than or equal to 2.5 wt %. In embodiments, the amount of compatibilizer in the polymer blend may be less than or equal to 5 wt %, less than or equal to 4 wt %, or even less than or equal to 3 wt %. In embodiments, the amount of compatibilizer in the polymer blend may be greater than 0 wt % and less than or equal to 5 wt %, greater than 0 wt % and less than or equal to 4 wt %, greater than 0 wt % and less than or equal to 3 wt %, greater than or equal to 1 wt % and less than or equal to 5 wt %, greater than or equal to 1 wt % and less than or equal to 4 wt %, greater than or equal to 1 wt % and less than or equal to 3 wt %, greater than or equal to 1.25 wt % and less than or equal to 5 wt %, greater than or equal to 1.25 wt % and less than or equal to 4 wt %, greater than or equal to 1.25 wt % and less than or equal to 3 wt %, greater than or equal to 2 wt % and less than or equal to 5 wt %, greater than or equal to 2 wt % and less than or equal to 4 wt %, greater than or equal to 2 wt % and less than or equal to 3 wt %, greater than or equal to 2.5 wt % and less than or equal to 5 wt %, greater than or equal to 2.5 wt % and less than or equal to 4 wt %, or even greater than or equal to 2.5 wt % and less than or equal to 3 wt %, or any and all sub-ranges formed from any of these endpoints.

In embodiments, the compatibilizer may comprise styrene maleic anhydride (SMA), aromatic polyketone, maleated-ABS, polystyrene sulfonate, acrylic copolymers, or a combination thereof.

In embodiments, the compatibilizer may have a weight average molecular weight (Mw) greater than or equal to 4000 g/mol or even greater than or equal to 5000 g/mol. In embodiments, the compatibilizer may have a weight average molecular weight (Mw) less than or equal to 7000 g/mol or even less than or equal to 6000 g/mol. In embodiments, the compatibilizer may have a weight average molecular weight (Mw) greater than or equal to 4000 g/mol and less than or equal to 7000 g/mol, greater than or equal to 4000 g/mol and less than or equal to 6000 g/mol, greater than or equal to 5000 g/mol and less than or equal to 7000 g/mol, or even greater than or equal to 5000 g/mol and less than or equal to 6000 g/mol, or any and all sub-ranges formed from any of these endpoints.

In embodiments, the compatibilizer may have an acid value greater than or equal to 400 mg KOH/g or even greater than 450 mg KOH/g. In embodiments, the compatibilizer may have an acid value less than or equal to 550 mg KOH/g or even less than or equal to 500 mg KOH/g. In embodiments, the compatibilizer may have an acid value greater than or equal to 400 mg KOH/g and less than or equal to 550 mg KOH/g, greater than or equal to 400 mg KOH/g and less than or equal to 500 mg KOH/g, greater than or equal to 450 mg KOH/g and less than or equal to 550 mg KOH/g, or even greater than or equal to 450 mg KOH/g and less than or equal to 500 mg KOH/g.

In embodiments, the compatibilizer may have a glass transition temperature greater than or equal to 100° C. or even greater than or equal to 125° C. In embodiments, the compatibilizer may have a glass transition temperature less than or equal to 175° C. or even less than or equal to 150° C. In embodiments, the compatibilizer may have a glass transition temperature greater than or equal to 100° C. and less than or equal to 175° C., greater than or equal to 100° C. and less than or equal to 150° C., greater than or equal to 125° C. and less than or equal to 175° C., or even greater than or equal to 125° C. and less than or equal to 150° C., or any and all sub-ranges formed from any of these endpoints.

Suitable commercial embodiments of the compatibilizer are available under the XIBOND brand from Polyscope, such as grade 285; under the BONDYRAM brand from Polyram Group, such as 6000; under the METBLEN brand from Mitsubishi Chemical; and ethylene acrylate based terpolymers from Lotader. Table 5 shows certain properties of XIBOND 285.

TABLE 5

| | XIBOND 285 |
|---|---|
| Mw (g/mol) | 5000 |
| Acid value (mg KOH/g) | 480 |
| Glass transition temperature (° C.) | 130 |

Filler

In embodiments, the polymer blend may further comprise a filler. In embodiments, the filler may comprise adhesion promoters; biocides; anti-fogging agents; anti-static agents; blowing and foaming agents; bonding agents and bonding polymers; dispersants; flame retardants and smoke suppressants; impact modifiers; initiators; lubricants; micas; pigments, colorants, and dyes; processing aids; release agents; silanes, titanates, and zirconates; slip and anti-blocking agents; stearates; ultraviolet light absorbers; viscosity regulators; waxes; or combinations thereof.

In embodiments, the amount of filler in the polymer blend may be greater than 0 wt % or even greater than or equal to 0.1 wt %. In embodiments, the amount of the filler in the polymer blend may be less than or equal to 1 wt %, less than or equal to 0.75 wt %, or even less than or equal to 0.5 wt %. In embodiments, the amount of the filler in the polymer blend may be greater than 0 wt % and less than or equal to 1 wt %, greater than 0 wt % and less than or equal to 0.75 wt %, greater than 0 wt % and less than or equal to 0.5 wt %, greater than or equal to 0.1 wt % and less than or equal to 1 wt %, greater than or equal to 0.1 wt % and less than or equal to 0.75 wt %, or even greater than or equal to 0.1 wt % and less than or equal to 0.5 wt %, or any and all sub-ranges formed from any of these endpoints.

Suitable commercial embodiments of the filler are available under the IRGAFOS 168 brand from BASF, such as grade 168 and under the IRGANOX brand from BASF, such as grade 1098 and 1010.

Processing

In embodiments, the polymer blend described herein may be made with batch process or continuous process.

In embodiments, the components of the polymer blend may be added all together in an extruder and mixed. In embodiments, mixing may be a continuous process at an elevated temperature (e.g., 230° C.-275° C.) that is sufficient to melt the polymer matrix. In embodiments, fillers may be added at the feed-throat, or by injection or side-feeders downstream. In embodiments, the output from the extruder is pelletized for later extrusion, molding, thermoforming, foaming, calendaring, and/or other processing into polymeric articles.

### EXAMPLES

Table 6 shows sources of ingredients for the polymer blends of Comparative Examples C1-C8 and Examples 1-5.

TABLE 6

| Ingredient | Brand | Source |
|---|---|---|
| aliphatic polyketone | POKETONE M330A | Hyosung Polyketone |
| aliphatic polyketone | POKETONE M630A | Hyosung Polyketone |
| ABS | LUSTRAN 433 | INEOS Styrolution |
| hydroxyapatite stabilizer | EPSOLUTE C13-09 | Budenheim |
| (tricalcium phosphate) | | |
| rubber-containing impact modifier | BLENDEX 338 | Galata Chemicals |
| (high rubber ABS) | | |
| antioxidant | IRGAFOS 168 | BASF |
| antioxidant | IRGANOX 1098 | BASF |

Method of Environmental Stress Cracking (ESCR)

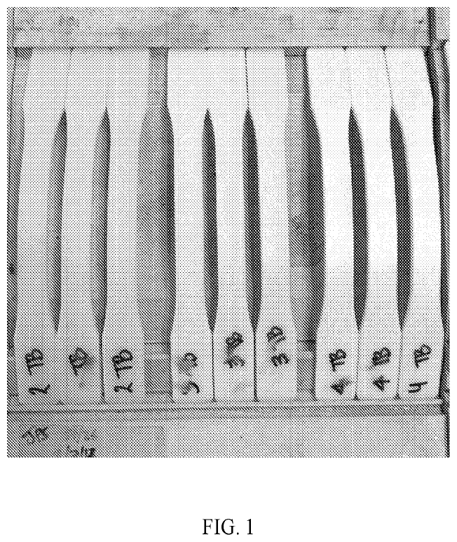

Sample bars having the formulations of the Comparative Examples and Examples shown in Tables 8-10 are formed. To decouple the effect of strain from the exhibited chemical resistance of the Comparative Example and Example formulations, the sample bars are placed in a strain jig and subjected to a fixed strain as shown in FIG. 1. For the “1% Strain Control” examples, the sample bars are put under strain for a period of 72 hours. The tensile modulus, tensile strength at yield, and tensile elongation at yield of the strained control sample bars are measured and shown in Tables 8-10. For the other examples, the sample bars are put under strain and exposed to a chemical for 72 hours. The sample bars are exposed to a chemical by placing a gauze pad that has been soaked in the chemical on the sample bar, letting the gauze pad sit on the sample bar for 24 hours, removing the gauze pad, and placing a newly soaked gauze pad on the sample bar. This is repeated two more times. The tensile modulus, tensile strength at yield, and tensile elongation at yield of the chemically exposed sample bars are measured and shown in Tables 8-10. The tensile modulus retention, tensile strength at yield retention, and the tensile elongation at yield retention of the chemically exposed sample bars are calculated relative to the strained control sample bars and shown in Tables 8-10. A formulation is considered to have “good chemical resistance” when the property retentions for tensile modulus, tensile strength at yield, and tensile elongation property retention are between 90% and 110%. A formulation is considered to have “superior chemical resistance” when the property retentions for tensile modulus, tensile strength at yield, and tensile elongation at yield are between 95% and 105%. A formulation is considered to have “inferior chemical resistance” when any of the property retentions for tensile modulus, tensile strength at yield, and tensile elongation at yield are less than 90% or greater than 110%.

Table 7 shows the chemicals used in the ESCR testing.

TABLE 7

| Ingredients | Brand | Source |
|---|---|---|
| diethylene glycol butyl ether, N-alkyl | VIREX TB | Diversey |
| dimethyl benzyl ammounium chloride, and | | |
| N-alkyl dimethyl ethylbenzyl ammonium | | |
| chloride | | |
| peracetic acid and hydrogen peroxide | SPORGON | Decon Labs, Inc. |
| isopropanol, 2-butoxyethanol, and | CAVICIDE | Metrex |
| diisobutylphenozyethoxyethyldimethylbenzyl | | |
| ammonium chloride | | |
| 1,2 - benzenedicarboxyaldehyde | CIDEX OPA | American Sterilization |
| | | Products |
| phosphoric acid, 2-phenylphenol, 4-tert- | BIREX SE Concentrate | Biotrol |
| pentylphenol, and isopropyl alcohol | | |
| phosphoric acid 30% solution | ACS Reagent | Sigma Aldrich |
| nitric acid 10% solution | ACS Reagent | Sigma-Aldrich |

Table 8 shows the formulations (in wt %), certain properties, and ESCR results of Comparative Examples C1-C4 and Examples 1 and 2. Comparative Examples C1-C4 and Examples 1 and 2 include different ratios of POKETONE M330A to LUSTRAN 433, ranging from 1:0 in Comparative Example C1 to 0:1 in Comparative Example C4.

TABLE 8

| Examples | C1 | 1 | 2 | C2 | C3 | C4 |
|---|---|---|---|---|---|---|
| Ratio of POKETONE M330A to | 1:0 | 5.7:1 | 2.3:1 | 1:1 | 0.4:1 | 0:1 |
| LUSTRAN 433 | | | | | | |
| POKETONE M330A | 99.1 | 84.235 | 69.37 | 49.55 | 29.73 | 0 |
| LUSTRAN 433 | 0 | 14.865 | 29.73 | 49.55 | 69.37 | 99.1 |
| EPSOLUTE C13-09 | 0.5 | 0.5 | 0.5 | 0.5 | 0.5 | 0.5 |
| IRGANOX 1098 | 0.25 | 0.25 | 0.25 | 0.25 | 0.25 | 0.25 |
| IRGAFOS 168 | 0.15 | 0.15 | 0.15 | 0.15 | 0.15 | 0.15 |
| Heat deflection temp. (° C.) | 186 | 163 | 115 | 94 | 93 | 89 |
| Tensile modulus (MPa) | 1537 | 1603 | 1732 | 2025 | 2147 | 2329 |
| Tensile strength at yield (MPa) | 58 | 48 | 46 | 44 | 46 | 47 |
| Tensile elongation at yield (%) | 16 | 10 | 10 | 5.0 | 3.5 | 2.9 |
| Tensile strength at break (MPa) | 29 | 48 | 46 | 40 | 33 | 34 |
| Tensile elongation at break (%) | 225 | 17 | 13 | 20 | 25 | 14 |
| Flexural modulus (MPa) | 1557 | 1602 | 1783 | 1879 | 2057 | 2410 |
| Flexural strength (MPa) | 64 | 65 | 70 | 71 | 75 | 78 |

ESCR (1% Strain Control)

| | | | | | | |
|---|---|---|---|---|---|---|
| Tensile modulus (MPa) | 1506 | 1708 | 1846 | 2045 | 2214 | 2669 |
| Tensile strength at yield (MPa) | 58 | 49 | 46 | 44 | 47 | 48 |
| Tensile elongation at yield (%) | 16 | 10 | 10 | 5.0 | 3.4 | 2.6 |

ESCR (VIREX TB)

| | | | | | | |
|---|---|---|---|---|---|---|
| Tensile modulus (MPa) | 1571 | 1789 | 1848 | 2211 | 2724 | Samples |
| Tensile modulus retention | 104 | 105 | 100 | 108 | 123 | broke in |
| (% relative to strain control) | | | | | | strain |
| Tensile strength at yield (MPa) | 56 | 49 | 46 | 44 | 13 | holder |
| Tensile strength at yield retention | 97 | 100 | 100 | 100 | 27 | |
| (% relative to strain control) | | | | | | |
| Tensile elongation at yield (%) | 14 | 10 | 10 | 4.9 | 0.6 | |
| Tensile strength at elongation retention | 84 | 100 | 100 | 97 | 18 | |
| (% relative to strain control) | | | | | | |

ESCR (SPORGON)

| | | | | | | |
|---|---|---|---|---|---|---|
| Tensile modulus (MPa) | 1590 | 1770 | 1936 | 2189 | 2396 | 2694 |
| Tensile modulus retention | 106 | 104 | 105 | 107 | 108 | 101 |
| (% relative to strain control) | | | | | | |
| Tensile strength at yield (MPa) | 57 | 49 | 46 | 44 | 46 | 46 |
| Tensile strength at yield retention | 98 | 101 | 101 | 99 | 99 | 96 |
| (% relative to strain control) | | | | | | |
| Tensile elongation at yield (%) | 14 | 10 | 10 | 4.9 | 3.3 | 2.6 |
| Tensile strength at elongation retention | 88 | 100 | 100 | 99 | 94 | 100 |
| (% relative to strain control) | | | | | | |

As shown in Table 8, Example 1 (5.7:1 POKETONE M330A to LUSTRAN 433 polymer blend) and Example 2 (2.3:1 POKETONE M330A to LUSTRAN 433 polymer blend) have heat deflection temperatures of 163° C. and 115° C., respectively. Comparative Example C2 (1:1 POKETONE M330A to LUSTRAN 433 polymer blend), Comparative Example C3 (0.4:1 POKETONE M330A to LUSTRAN 433 polymer blend), and Comparative Example C4 (0:1 POKETONE M330A to LUSTRAN 433 polymer blend) have heat deflection temperatures of 94° C., 93° C., and 89° C., respectively. As indicated by the examples shown in Table 8, heat deflection temperature increases as the amount of aliphatic polyketone increases and the amount of ABS decreases. Accordingly, the amount of aliphatic polyketone may be balanced with the amount of ABS, such as in Examples 1 and 2, to achieve a desired heat deflection temperature of greater than 100° C. Comparative Examples C2 to C4 having 1:1, 0.4:1, and 0:1 ratios, respectively, of aliphatic polyketone to ABS have heat deflection temperatures less than 100° C.

Example 1 (5.7:1 POKETONE M330A to LUSTRAN 433 polymer blend) and Example 2 (2.3:1 POKETONE M330A to LUSTRAN 433 polymer blend) have higher tensile modulus and flexural modulus as compared to Comparative Example C1 (0:1 POKETONE M330A to LUSTRAN 433 polymer blend). As indicated by the examples shown in Table 8, tensile modulus and flexural modulus increases as the amount of ABS increases and the amount of aliphatic polyketone decreases. Accordingly, the amount of ABS may be balanced with the amount of aliphatic polyketone, such as in Examples 1 and 2, to achieve a higher tensile modulus and flexural modulus.

Along with a tensile modulus of 1603 MPa and a flexural modulus of 1602 MPa, Example 1 (5.7:1 POKETONE M330A to LUSTRAN 433 polymer blend) exhibits overall sufficient tensile and flexural strength and stiffness with a tensile strength at yield of 48 MPa, tensile elongation at yield of 10%, a tensile strength at break of 48 MPa, a tensile elongation at break of 17%, and a flexural strength of 65 MPa. Similarly, along with a tensile modulus of 1732 MPa and a flexural modulus 1783 MPa, Example 2 (2.3:1 POKETONE M330A to LUSTRAN 433 polymer blend) exhibits overall sufficient tensile and flexural strength and stiffness with a tensile strength at yield of 46 MPa, a tensile elongation at yield of 10%, a tensile strength at break of 46 MPa, a tensile elongation at break of 13%, and a flexural strength of 70 MPa.

In addition to having a heat deflection temperature of greater than 100° C. and sufficient tensile and flexural strength and stiffness, Examples 1 and 2 show superior chemical resistance against VIREX TB and SPORGON. Comparative Example C1 (1:0 POKETONE M330A to LUSTRAN 433 polymer blend) shows inferior chemical resistance against VIREX TB and SPORGON. Comparative Example C4 (0:1 POKETONE M330A to LUSTRAN 433) shows inferior chemical resistance against SPORGON. The sample bars for Comparative Example C4 broke in the strain holder when exposed to VIREX TB. As indicated by the examples shown in Table 8, 5.7:1 and 2.3:1 aliphatic polyketone to ABS polymer blends exhibit better chemical resistance than aliphatic polyketone only blends and ABS only blends.

Table 9 shows the formulations (in wt %), certain properties, and ESCR results of Comparative Examples C5-C8 and Examples 3 and 4. Comparative Examples C5 and C7 are aliphatic polyketone only blends. Examples 3 and 4 are 2.3:1 aliphatic polyketone to ABS polymer blends. Comparative Examples C6 and C8 are 1:1 aliphatic polyketone to ABS polymer blends.

TABLE 9

| Examples | C5 | 3 | C6 | C7 | 4 | C8 |
|---|---|---|---|---|---|---|
| Ratio of POKETONE to LUSTRAN 433 | 1:0 | 2.3:1 | 1:1 | 1:0 | 2.3:1 | 1:1 |
| POKETONE M330A | 99.1 | 69.37 | 49.55 | 0 | 0 | 0 |
| POKETONE M630A | 0 | 0 | 0 | 99.1 | 69.37 | 49.55 |
| LUSTRAN 433 | 0 | 29.73 | 49.55 | 0 | 29.73 | 49.55 |
| EPSOLUTE C13-09 | 0.5 | 0.5 | 0.5 | 0.5 | 0.5 | 0.5 |
| IRGANOX 1098 | 0.25 | 0.25 | 0.25 | 0.25 | 0.25 | 0.25 |
| IRGAFOS 168 | 0.15 | 0.15 | 0.15 | 0.15 | 0.15 | 0.15 |
| Heat deflection temp. (° C.) | 191 | 101 | 92 | 194 | 110 | 96 |
| Tensile modulus (MPa) | 1492 | 1800 | 1911 | 1319 | 1640 | 1891 |
| Tensile strength at yield (MPa) | 58 | 47 | 45 | 56 | 47 | 43 |
| Tensile elongation at yield (%) | 16 | 12 | 5.1 | 19 | 12 | 5.6 |
| Tensile strength at break (MPa) | 36 | 45 | 40 | 60 | 60 | 38 |
| Tensile elongation at break (%) | 183 | 20 | 22 | 352 | 293 | 120 |
| Flexural modulus (MPa) | 1557 | 1682 | 1866 | 1397 | 1719 | 1967 |
| Flexural strength (MPa) | 62 | 66 | 70 | 59 | 67 | 72 |

ESCR (1% Strain Control)

| | | | | | | |
|---|---|---|---|---|---|---|
| Tensile modulus (MPa) | 1567 | 1802 | 1982 | 1236 | 1712 | 1984 |
| Tensile strength at yield (MPa) | 56 | 47 | 45 | 54 | 49 | 46 |
| Tensile elongation at yield (%) | 16 | 12 | 7.2 | 18 | 12 | 5.4 |

ESCR (VIREX TB)

| | | | | | | |
|---|---|---|---|---|---|---|
| Tensile modulus (MPa) | 1576 | 1772 | 2084 | 1344 | 1818 | 2223 |
| Tensile modulus retention | 101 | 98 | 105 | 109 | 106 | 112 |
| (% relative to strain control) | | | | | | |
| Tensile strength at yield (MPa) | 59 | 47 | 38 | 58 | 49 | 46 |
| Tensile strength at yield retention | 106 | 100 | 85 | 107 | 101 | 102 |
| (% relative to strain control) | | | | | | |
| Tensile elongation at yield (%) | 16 | 12 | 2.5 | 18 | 12 | 5.5 |
| Tensile strength at elongation retention | 95 | 100 | 35 | 98 | 98 | 102 |
| (% relative to strain control) | | | | | | |

ESCR (SPORGON)

| | | | | | | |
|---|---|---|---|---|---|---|
| Tensile modulus (MPa) | 1638 | 1925 | 1975 | 1318 | 1634 | 2086 |
| Tensile modulus retention | 105 | 107 | 100 | 107 | 95 | 105 |
| (% relative to strain control) | | | | | | |
| Tensile strength at yield (MPa) | 56 | 45 | 44 | 54 | 46 | 46 |
| Tensile strength at yield retention | 99 | 96 | 98 | 99 | 94 | 100 |
| (% relative to strain control) | | | | | | |
| Tensile elongation at yield (%) | 14 | 10 | 5.0 | 18 | 12 | 5.2 |
| Tensile strength at elongation retention | 88 | 85 | 69 | 103 | 102 | 97 |
| (% relative to strain control) | | | | | | |

ESCR (CAVICIDE)

| | | | | | | |
|---|---|---|---|---|---|---|
| Tensile modulus (MPa) | 1617 | 1861 | 2068 | 1439 | 1678 | 2199 |
| Tensile modulus retention | 103 | 103 | 104 | 116 | 98 | 111 |
| (% relative to strain control) | | | | | | |
| Tensile strength at yield (MPa) | 57 | 48 | 46 | 56 | 48 | 47 |
| Tensile strength at yield retention | 101 | 102 | 101 | 103 | 99 | 103 |
| (% relative to strain control) | | | | | | |
| Tensile elongation at yield (%) | 14 | 12 | 4.8 | 18 | 12 | 11 |
| Tensile strength at elongation retention | 88 | 98 | 67 | 101 | 99 | 209 |
| (% relative to strain control) | | | | | | |

ESCR (CIDEX OPA)

| | | | | | | |
|---|---|---|---|---|---|---|
| Tensile modulus (MPa) | 1500 | 1898 | 2159 | 1151 | 1772 | 2093 |
| Tensile modulus retention | 96 | 105 | 109 | 93 | 104 | 106 |
| (% relative to strain control) | | | | | | |
| Tensile strength at yield (MPa) | 54 | 46 | 45 | 51 | 49 | 45 |
| Tensile strength at yield retention | 95 | 98 | 100 | 94 | 100 | 100 |
| (% relative to strain control) | | | | | | |
| Tensile elongation at yield (%) | 16 | 10 | 4.9 | 18 | 12 | 5.1 |
| Tensile strength at elongation retention | 100 | 85 | 68 | 101 | 100 | 94 |
| (% relative to strain control) | | | | | | |

ESCR (BIREX SE)

| | | | | | | |
|---|---|---|---|---|---|---|
| Tensile modulus (MPa) | 1656 | 1960 | 2184 | 1408 | 1691 | 2113 |
| Tensile modulus retention | 106 | 109 | 110 | 114 | 99 | 106 |
| (% relative to strain control) | | | | | | |
| Tensile strength at yield (MPa) | 59 | 47 | 46 | 56 | 48 | 47 |
| Tensile strength at yield retention | 104 | 101 | 103 | 104 | 100 | 103 |
| (% relative to strain control) | | | | | | |
| Tensile elongation at yield (%) | 17 | 11 | 4.9 | 19 | 12 | 10 |
| Tensile strength at elongation retention | 101 | 93 | 68 | 103 | 100 | 176 |
| (% relative to strain control) | | | | | | |

ESCR (Phosphoric acid 30% solution)

| | | | | | | |
|---|---|---|---|---|---|---|
| Tensile modulus (MPa) | 1330 | 1729 | 2072 | 1169 | 1574 | 2034 |
| Tensile modulus retention | 85 | 96 | 105 | 95 | 92 | 103 |
| (% relative to strain control) | | | | | | |
| Tensile strength at yield (MPa) | 47 | 44 | 45 | 47 | 44 | 45 |
| Tensile strength at yield retention | 83 | 94 | 100 | 87 | 91 | 99 |
| (% relative to strain control) | | | | | | |
| Tensile elongation at yield (%) | 14 | 10 | 5.0 | 17 | 12 | 5.5 |
| Tensile strength at elongation retention | 85 | 86 | 70 | 96 | 99 | 102 |
| (% relative to strain control) | | | | | | |

ESCR (Nitric acid 10% solution)

| | | | | | | |
|---|---|---|---|---|---|---|
| Tensile modulus (MPa) | 1630 | 1963 | 2183 | 1599 | 1736 | 2159 |
| Tensile modulus retention | 104 | 109 | 110 | 129 | 101 | 109 |
| (% relative to strain control) | | | | | | |
| Tensile strength at yield (MPa) | 34 | 43 | 45 | 52 | 49 | 47 |
| Tensile strength at yield retention | 60 | 92 | 101 | 96 | 100 | 102 |
| (% relative to strain control) | | | | | | |
| Tensile elongation at yield (%) | 3.3 | 4.5 | 4.9 | 11 | 12 | 5.2 |
| Tensile strength at elongation retention | 20 | 38 | 68 | 62 | 100 | 95 |
| (% relative to strain control) | | | | | | |

As shown in Table 9, Example 3 (2.3:1 POKETONE M330A to LUSTRAN 433 polymer blend) and Example 4 (2.3:1 POKETONE M630A to LUSTRAN 433 polymer blend) have heat deflection temperatures of 101° C. and 110° C., respectively. Comparative Example C6 (1:1 POKETONE M330A to LUSTRAN 433 polymer blend) and Comparative Example C8 (1:1 POKETONE M630A to LUSTRAN 433 polymer blend) have heat deflection temperatures of 92° C. and 96° C., respectively. As indicated by the examples shown in Table 9, heat deflection temperature increases as the amount of aliphatic polyketone increases and the amount of ABS decreases. Accordingly, the amount of aliphatic polyketone may be balanced with the amount of ABS, such as in Examples 3 and 4, to achieve a desired heat deflection temperature greater than 100° C. Comparative Examples C6 to C8 having 1:1 ratios of aliphatic polyketone to ABS have heat deflection temperatures less than 100° C.

Example 3 (2.3:1 POKETONE M330A to LUSTRAN 433 polymer blend) and Example 4 (2.3:1 POKETONE M630A to LUSTRAN 433 polymer blend) have higher tensile modulus and flexural modulus as compared to Comparative Example C5 (1:0 POKETONE M330A to LUSTRAN 433 polymer blend) and Comparative Example C7 (1:0 POKETONE M630A to LUSTRAN 433 polymer blend). As indicated by the examples shown in Table 9, tensile modulus and flexural modulus increases as the amount of ABS increases and the amount of aliphatic polyketone decreases. Accordingly, the amount of ABS may be balanced with the amount of aliphatic polyketone, such as in Examples 3 and 4, to achieve a higher tensile modulus and flexural modulus.

Along with a tensile modulus of 1800 MPa and a flexural modulus of 1682 MPa, Example 3 (2.3:1 POKETONE M330A to LUSTRAN 433 polymer blend) exhibits overall sufficient tensile and flexural strength and stiffness with a tensile strength at yield of 47 MPa, a tensile elongation at yield of 12%, a tensile strength at break of 45 MPa, a tensile elongation at break of 20%, and a flexural strength of 66 MPa. Similarly, along with a tensile modulus of 1640 MPa and a flexural modulus of 1719 MPa, Example 4 (2.3:1 POKETONE M630A to LUSTRAN 433 polymer blend) exhibits overall sufficient tensile and flexural strength and stiffness with a tensile strength at yield of 47 MPa, a tensile elongation at yield of 12%, a tensile strength at break of 60 MPa, a tensile elongation at break of 293%, and a flexural strength of 67 MPa.

In addition to having a heat deflection temperature of greater than 100° C. and sufficient tensile and flexural strength and stiffness, Example 3 (2.3:1 POKETONE M330A to LUSTRAN 433 polymer blend) shows superior chemical resistance against VIREX TB and CAVICIDE and shows good chemical resistance against BIREX SE. While Example 3 shows inferior chemical resistance against Phosphoric acid 30% solution and Nitric acid 10% solution, Example 3 shows improved chemical resistance to Phosphoric acid 30% solution and Nitric acid 10% solution as compared to Comparative Example C5 (1:0 POKETONE M330A to LUSTRAN 433 polymer blend) as evidenced by the property retention values. As indicated by the examples shown in Table 9, a 2.3:1 aliphatic polyketone to ABS polymer blend exhibits better chemical resistance than an aliphatic polyketone only blend.

In addition to having a heat deflection temperature of greater than 100° C. and sufficient tensile and flexural strength and stiffness, Example 4 (2.3:1 POKETONE M630A to LUSTRAN 433 polymer blend) shows superior chemical resistance against CAVICIDE, CIDEX OPA, BIREX SE, and Nitric acid 10% solution, and shows good chemical resistance against VIREX TB, SPORGON, and Phosphoric acid 30% solution. Example 4 shows better chemical resistance against SPORGON, CIDEX OPA, Phosphoric acid 30% solution, and Nitric acid 10% solution than Example 3 (2.3:1 POKETONE M330A to LUSTRAN 433 polymer blend), which shows inferior chemical resistance for these chemicals. While not wishing to be bound by theory, it is believed that the different properties of POKETONE M330A and POKETONE M630A lead to these chemical resistance variances. For example, the higher viscosity of POKETONE M630A resulting from its relatively lower melt flow rate (i.e., 6 g/10 min) may more adequately disperse the ABS and provide a more uniform blend as compared to a blend including POKETONE M330A having a relatively higher melt flow rate (i.e., 60 g/10 min).

Table 10 shows the formulation (in wt %), certain properties, and ESCR results of Example 5. Example 5 includes a rubber-containing impact modifier (i.e., BLENDEX 338).

TABLE 10

| Example | 5 |
|---|---|
| Ratio of POKETONE M630A to | 4.7:1 |
| LUSTRAN | |
| POKETONE M630A | 69.37 |
| LUSTRAN 433 | 14.865 |
| BLENDEX 338 | 14.865 |
| EPSOLUTE C13-09 | 0.5 |
| IRGANOX 1098 | 0.25 |
| IRGAFOS 168 | 0.15 |
| Notched Izod Impact strength (J/m) | 988 |
| Type of notched break | Partial |
| Heat deflection temp. (° C.) | 118 |
| Tensile modulus (MPa) | 1285 |
| Tensile strength at yield (MPa) | 41 |
| Tensile elongation at yield (%) | 21 |
| Tensile strength at break (MPa) | 42 |
| Tensile elongation at break (%) | 193 |
| Flexural modulus (MPa) | 1371 |
| Flexural strength (MPa) | 52 |

ESCR (1% Strain Control)

| | |
|---|---|
| Tensile modulus (MPa) | 565 |
| Tensile strength at yield (MPa) | 41 |
| Tensile elongation at yield (%) | 20 |

ESCR (VIREX TB)

| | |
|---|---|
| Tensile modulus (MPa) | 549 |
| Tensile modulus retention | 97 |
| (% relative to strain control) | |
| Tensile strength at yield (MPa) | 41 |
| Tensile strength at yield retention | 99 |
| (% relative to strain control) | |
| Tensile elongation at yield (%) | 20 |
| Tensile strength at elongation retention | 99 |
| (% relative to strain control) | |

ESCR (CAVICIDE)

| | |
|---|---|
| Tensile modulus (MPa) | 558 |
| Tensile modulus retention | 99 |
| (% relative to strain control) | |
| Tensile strength at yield (MPa) | 41 |
| Tensile strength at yield retention | 100 |
| (% relative to strain control) | |
| Tensile elongation at yield (%) | 20 |
| Tensile strength at elongation retention | 101 |
| (% relative to strain control) | |

ESCR (CIDEX OPA)

| | |
|---|---|
| Tensile modulus (MPa) | 546 |
| Tensile modulus retention | 97 |
| (% relative to strain control) | |
| Tensile strength at yield (MPa) | 40 |
| Tensile strength at yield retention | 98 |
| (% relative to strain control) | |
| Tensile elongation at yield (%) | 20 |
| Tensile strength at elongation retention | 101 |
| (% relative to strain control) | |

As shown in Table 10, Example 5 (4.7:1 POKETONE M630A to LUSTRAN 433 polymer blend including BLENDEX 338) has a heat deflection temperature of 118° C. and superior chemical resistance against VIREX TB, CAVICIDE, and CIDEX OPA. Example 5 has sufficient tensile and flexural strength and stiffness with a tensile modulus of 1285 MPa, a tensile strength at yield of 41 MPa, a tensile elongation at yield of 21%, a tensile strength at break of 42 MPa, a tensile elongation at break 193%, a flexural modulus of 1371 MPa, and a flexural strength of 52 MPa. In addition to having the increased heat deflection temperature, sufficient tensile and flexural strength and stiffness, and chemical resistance, Example 5 has a Notched Izod Impact strength of 988 J/m. As indicated by Example 5 shown in Table 10, the addition of a rubber-containing impact modifier to an aliphatic polyketone and ABS blend as described herein may result in a polymer blend that exhibits increased chemical resistance and impact resistance.

It will be apparent that modifications and variations are possible without departing from the scope of the disclosure defined in the appended claims. More specifically, although some aspects of the present disclosure are identified herein as preferred or particularly advantageous, it is contemplated that the present disclosure is not necessarily limited to these aspects.

What is claimed is:

1. A polymer blend comprising:
greater than or equal to 55 wt % and less than or equal to 90 wt % of an aliphatic polyketone; and
greater than or equal to 10 wt % and less than or equal to 40 wt % of an acrylonitrile butadiene styrene (ABS),
wherein the aliphatic polyketone has a melt flow rate greater than or equal to 1 g/10 min and less than or equal to 90 g/10 min as measured in accordance with ASTM D1238 at 240° C. and a weight of 2.16 kg.

2. The polymer blend of claim 1, wherein the polymer blend further comprises greater than 0 wt % and less than or equal to 1 wt % of a hydroxyapatite stabilizer.

3. The polymer blend of claim 2, wherein the hydroxyapatite stabilizer is pentacalcium hydroxide tris(orthophosphate), amorphous tricalcium hydroxyphosphate, calcium phosphate hydroxide, or a combination thereof.

4. The polymer blend of claim 1, wherein the aliphatic polyketone has a melt flow rate greater than or equal to 1 g/10 min and less than or equal to 20 g/10 min as measured in accordance with ASTM D1238 at 240° C. and a weight of 2.16 kg.

5. The polymer blend of claim 1, wherein the aliphatic polyketone has a melt flow rate greater than or equal to 40 g/10 min and less than or equal to 90 g/10 min as measured in accordance with ASTM D1238 at 240° C. and a weight of 2.16 kg.

6. The polymer blend of claim 1, wherein the polymer blend comprises greater than or equal to 60 wt % and less than or equal to 80 wt % of the aliphatic polyketone.

7. The polymer blend of claim 1, wherein the polymer blend comprises greater than or equal to 20 wt % and less than or equal to 40 wt % of the ABS.

8. The polymer blend of claim 1, wherein the polymer blend has a ratio by weight of aliphatic polyketone to ABS from 2:1 to 6:1.

9. The polymer blend of claim 1, wherein the polymer blend has a heat deflection temperature greater than or equal to 100° C. as measured in accordance with ASTM D648 at a 0.45 MPa load.

10. The polymer blend of claim 1, wherein the polymer blend has a tensile modulus greater than or equal to 1100 MPa as measured in accordance with ASTM D638 at 23° C. and a rate of strain of 0.85 mm/s.

11. The polymer blend of claim 1, wherein the polymer blend has a tensile strength at yield greater than or equal to 35 MPa as measured in accordance with ASTM D638 at 23° C. and a rate of strain of 0.85 mm/s.

12. The polymer blend of claim 1, wherein the polymer blend has a tensile elongation at yield greater than or equal to 8% as measured in accordance with ASTM D638 at 23° C. and a rate of strain of 0.85 mm/s.

13. (canceled)

14. (canceled)

15. (canceled)

16. (canceled)

17. The polymer blend of claim 1, wherein the polymer blend has a tensile modulus greater than or equal to 1100 MPa as measured in accordance with ASTM D638 at 23° C. and a rate of strain of 0.85 mm/s, a tensile strength at yield greater than or equal to 35 MPa as measured in accordance with ASTM D638 at 23° C. and a rate of strain of 0.85 mm/s, a tensile elongation at yield greater than or equal to 8% as measured in accordance with ASTM D638 at 23° C. and a rate of strain of 0.85 mm/s, a tensile strength at break greater than or equal to 35 MPa as measured in accordance with ASTM D638 at 23° C. and a rate of strain of 0.85 mm/s, a tensile elongation at break greater than or equal to 8% as measured in accordance with ASTM D638 at 23° C. and a rate of strain of 0.85 mm/s, a flexural modulus greater than or equal to 1200 MPa as measured in accordance with ASTM D790 at 23° C. and a rate of strain 0.21 mm/s, and a flexural strength greater than or equal to 45 MPa as measured in accordance with ASTM D790 at 23° C. and a rate of strain 0.21 mm/s.

18. The polymer blend of claim 1, wherein the polymer blend further comprises greater than 0 wt % and less than or equal to 20 wt % of a rubber-containing impact modifier.

19. (canceled)

20. The polymer blend of claim 18, wherein the polymer blend has a Notched Izod Impact strength greater than or equal to 400 J/m.

21. The polymer blend of claim 1, wherein the polymer blend further comprises greater than 0 wt % and less than or equal to 5 wt % of a compatibilizer.

22. (canceled)
